(19) United States
(12) Patent Application Publication
(10) Pub. No.: US 2023/0201794 A1
(43) Pub. Date: Jun. 29, 2023

(54) POROUS GLASS FILTER AND MANUFACTURING METHOD THEREOF

(71) Applicant: Korea New Ceramics Co., Ltd., Bucheon-si (KR)

(72) Inventors: Ki Nam KIM, Seoul (KR); Jung Ho KIM, Seoul (KR)

(21) Appl. No.: 17/886,666

(22) Filed: Aug. 12, 2022

(30) Foreign Application Priority Data
Dec. 28, 2021 (KR) 10-2021-0189526

(51) Int. Cl. B01J 20/10; B01J 20/30

(52) U.S. Cl. CPC B01J 20/103; B01J 20/3071; B01J 20/3078; B01J 20/3021

(57) ABSTRACT

Provided is a porous glass filter obtained by heat-treating alkali borosilicate glass containing an alkali oxide (R₂O), boron trioxide (B₂O₃), and silica (SiO₂) as a composition at a glass transition temperature to phase-separate the alkali borosilicate glass into an alkali boro (R₂O—B₂O₃) phase and silica (SiO₂) phase, and obtained by thermal treatment or acid treatment to dissolve an alkali boro (R₂O—B₂O₃) phase. The manufacturing method includes: a glass forming step of melting and cooling alkali oxide (R₂O), boron trioxide (B₂O₃), and silica (SiO₂) to manufacture an alkali borosilicate glass; a phase separation step of heat-treating the alkali borosilicate glass at a glass transition temperature to phase separation of the alkali borosilicate glass into an alkali borosilicate (R₂O—B₂O₃) phase and a silica (SiO₂) phase; a micropore generation step of generating micropores by the dissolving alkali boro (R₂O—B₂O₃) phase by heat-treating or acid-treating the phase-separated alkali borosilicate glass.

### BACKGROUND OF THE INVENTION

### 1. Field of the Invention

The present disclosure relates to a porous glass filter for blocking siloxane or organic silicone that reduces gas sensitivity in a gas sensor for detecting combustible and reducing gas and a method for manufacturing the same. More particularly, the present disclosure relates to a porous glass filter with an excellent filtering effect due to its high porosity of 30% or more and its manufacturing method, in which the porous glass filter has a micropore diameter of 1 nm, so combustible and reducing gases such as hydrogen, methane, propane, and alcohols pass through and blocks the siloxane or silicone gas, thereby preventing poisoning of the gas sensor.

### 2. Description of the Related Art

Gas sensors are used not only in household kitchens and boiler rooms but also in explosive environments where combustible gas can be generated, such as factories, oil fields, mines, and underground sewer pipes. Gas sensors are also used in automobiles, power plants, and ships that use propane, natural gas, and hydrogen fuel.

These gas sensors include a metal oxide semiconductor (MOS) type gas sensor and contact combustion (pellistor) type gas sensor.

In metal oxide semiconductor sensors, when a sensor containing a precious metal catalyst such as platinum or palladium in a powder such as tin oxide (SnO₂) adsorbs oxygen in the atmosphere, the free electron of the sensor is trapped in the adsorbed oxygen, and the resistance is increased. The metal oxide semiconductor sensor uses a resistance change using a resistance change in which resistance is reduced by reacting with oxygen adsorbed to a sensor when combustible or reducing gas is generated, oxygen is desorbed, and free electrons trapped by oxygen are released. The sensor uses the principle that the higher the amount of gas, the more significant the change in resistance.

The pellistor gas sensor is formed by molding ceramic powder containing platinum or a palladium catalyst in a coil-shaped heater made of platinum having a high resistance temperature coefficient and high corrosion resistance in a bead shape to form a sensing bead or an activating bead. A compensating bead (reference bead) is made by forming another bead shape using the same ceramic powder without platinum or a palladium catalyst, and the sensing element and compensating element are connected in series and applied with a voltage of 2 to 5 V so that the surface temperature of the element becomes about 400° C. considering the resistance of the coil. At this time, if there is a combustible gas, oxidation or combustion occurs in the sensing element, and temperature of the sensing element increases, and the resistance of the platinum coil in the sensing element increases in proportion to the temperature. As the amount of gas increases, the resistance increases so that the gas concentration can be known.

Such a gas sensor is poisoned by siloxane or silicone, and the catalytic function of the gas sensor disappears, thereby degrading the sensitivity of the sensor. In particular, the pellistor gas sensor loses its function as a gas sensor because gas sensitivity is lowered even by a small amount of silicone. Silicone is commonly found in all areas of our lives, such as silicone adhesives such as glass windows of buildings and kitchens and bathrooms, siloxane in cosmetics, silicone oil, silicone rubber, and the like. As a result, the performance of the gas sensor is degraded so that the gas detector does not function or its life is shortened.

In particular, automobiles contain a significant amount of rubber or interior materials containing silicone. In hydrogen fuel cell automobiles that use hydrogen as fuel, a gas sensor for detecting hydrogen gas leakage is essential, and a decrease in gas sensitivity due to silicone is a serious risk factor.

In the meantime, various methods of using filters have been devised to prevent poisoning by silicone.

In Japanese Patent 3901602, a disk containing silicate powder containing platinum powder between porous fibers was manufactured and used as a filter, and in addition, a filter using zeolite, activated alumina, and activated carbon was also devised.

Such powder is used for molecular sieves, etc., has many pores, has a diameter of micropore of several Å to 10 Å, and has a very large specific surface area, so it is used as an adsorbent.

Since the size of the gas is about 2.4 Å for hydrogen, 2.8 Å for oxygen, 4.0 Å for methane, 4.9 Å for propane, 6.7 Å for benzene, and 7.4 Å for o-xylene, each gas can be filtered by using a molecular sieve with an appropriate micropore diameter.

These powders have a large particle size but have a structure in which numerous micropores are distributed in the particles. When this powder is placed in a porous cloth and placed in a gas pipeline and then passed through the gas, only gases of a size that can enter the micropore are captured, and larger gases pass between the powder particles. If only the gas trapped in the micropores is separated, only a specific gas can be filtered out.

Originally, gas sensors were used to adsorb alcohol to prevent malfunction due to alcohol by using the adsorption performance of these powders but gas sensors were also developed for adsorbing siloxane.

In order to manufacture these powders as filters, the powders are contained between porous fabrics or molded into a disk shape and heat treated. The filter manufactured in this way is installed in the part where the gas enters.

The gap between the powder particles is as large as several tens of nm to several micrometers. For this reason, when applied to a gas sensor, a gas having a large size, such as siloxane, is not trapped in micropores of zeolite or activated alumina and escapes between particles to contact the sensor sensing device, so there is little effect in preventing silicone. Rather, the gas to be detected is adsorbed to zeolite or activated alumina, which lowers gas sensitivity or slows the reaction rate, and lowers accuracy.

Japanese Patent Laid-Open No. 2018-176084 is characterized in that activated carbon having a micropore diameter of 1.5 to 3.0 nm is used to increase the adsorption of siloxane.

This is to capture and adsorb the siloxane into these micropores by using a micropore diameter larger than that of general activated carbon because the molecular size of siloxane is relatively large.

In this case, it has the effect of adsorbing more siloxane but does not prevent the siloxane from entering between the powder particles of activated carbon.

Since the sensitivity of the semiconductor gas sensor or pellistor gas sensor is severely reduced with only tens of ppm of siloxane, it has the effect of delaying poisoning by siloxane but does not prevent silicone poisoning.

Especially in automobiles, silicone rubber is used a lot, and the temperature is high, so silicone is generated in large quantities, so it is insufficient to prevent poisoning by silicone.

Since there is a limit to the amount of adsorption of activated carbon, if a certain amount or more is accumulated, the performance of activated carbon is lost and is useless. The same is true for activated alumina and zeolite.

### SUMMARY OF THE INVENTION

The present disclosure is devised to solve the problems of the related art. An objective of the present disclosure is to provide a porous glass filter capable of quickly and accurately detecting combustible and reducing gas in which the porous glass filter having a micropore size of 10 Å (1 nm) blocks the siloxane and silicone that cause poisoning so that the sensitivity is not reduced, and the porosity is higher than 30%.

The porous glass filter, according to the present disclosure, is obtained by heat-treating alkali borosilicate glass containing alkali oxide (R₂O), boron trioxide (B₂O₃), and silica (SiO₂) as a composition at a glass transition temperature to phase-separate the alkali borosilicate glass into an alkali boro (R₂O—B₂O₃) phase and silica (SiO₂) phase, and heat-treating or acid-treating alkali borosilicate glass having undergone the phase separation to dissolve an alkali boro (R₂O—B₂O₃) phase.

The alkali borosilicate glass has a weight ratio of 5% to 10% of alkali oxide (R₂O), 35% to 50% of boron trioxide (B₂O₃), and 40% to 55% of silica (SiO₂).

The method of manufacturing the porous glass filter, according to the present disclosure, may include:

preparing alkali borosilicate glass by melting and cooling alkali oxide (R₂O), boron trioxide (B₂O₃), and silica (SiO₂);

heat-treating the alkali borosilicate glass at a glass transition temperature to phase-separate the alkali borosilicate glass into an alkali borosilicate (R₂O—B₂O₃) phase and a silica (SiO₂) phase;

heat-treating or acid-treating the phase-separated alkali borosilicate glass having undergone the phase separation to dissolve the alkali boro (R₂O—B₂O₃) phase, thereby generating micropores.

The preparing alkali borosilicate glass includes:

melting and cooling the alkali oxide (R₂O), boron trioxide (B₂O₃), and silica (SiO₂) to produce primary glass;

a pulverizing the primary glass produced through the preparation of the alkali borosilicate glass;

melting the pulverized primary glass alkali in a graphite mold to remove air bubbles and then cooling the molten glass to produce the alkali borosilicate glass.

The porous glass filter, according to the present disclosure, has a pore diameter of 10 Å (1 nm) and a porosity of 30% or more so that combustible and reducing gases pass smoothly without clogging so that the gas sensor can detect the gas quickly and accurately. The present disclosure relates to a porous glass filter that prevents the sensitivity of a gas sensor from being degraded by blocking siloxane and silicone from being poisoned and a method thereof, which is low in cost and may be mass-produced and is very useful for industrial development.

### BRIEF DESCRIPTION OF THE DRAWINGS

FIG. 1 is a flowchart of a manufacturing method of a porous glass filter according to the present disclosure;

FIG. 2 is a schematic diagram intuitively expressing a manufacturing method of a porous glass filter according to the present disclosure;

FIG. 3 is a measurement circuit diagram for measuring the sensitivity of a gas sensor;

FIG. 4 is a graph of sensitivity change of the gas sensor according to the concentration of methane in the gas sensor according to the presence or absence of a filter and the type thereof;

FIG. 5 is a graph of sensitivity change of the gas sensor over time in the gas sensor according to the presence and type of filter;

FIG. 6 is a graph of sensitivity change of the gas sensor according to the concentration of another methane in the gas sensor according to the presence or absence of a filter and the type thereof.

### DESCRIPTION OF THE PREFERRED EMBODIMENTS

Hereinafter, the porous glass filter and the manufacturing method thereof according to the present disclosure will be described in more detail with reference to the drawings.

Prior to explaining in more detail respect to the porous glass filter and its manufacturing method according to the present disclosure, the present disclosure is intended to be described in detail in the text of the embodiment (aspect or example) and can be applied to various changes and can have various forms. However, this is not intended to limit the present disclosure to the specific disclosed form, it should be understood to include all modifications, equivalents, and substitutes included in the spirit and scope of the present disclosure.

In each drawing, the same reference numerals, in particular, the tens digit and the one digit number, or the tens digit, the one digit, and the same reference numerals in the alphabet, indicate members having the same or similar functions. If not specifically mentioned, the members referred to by each reference numeral in the drawing may be regarded as members corresponding to these criteria.

In addition, in each drawing, components are expressed in exaggeratedly large (or thick) or small (or thin) in size or thickness in consideration of convenience of understanding, etc., or simplified, but the scope of protection of the present disclosure should not be limitedly interpreted.

The terminology used herein is only used to describe a specific embodiment (aspect or example) and is not intended to limit the present disclosure. The singular expression includes the plural expression unless the context clearly dictates otherwise. In the present application, terms such as includes or consists of are intended to designate that the features, numbers, steps, operations, components, parts, or combinations thereof described in the specification exist and do not preclude the presence or addition of one or more other features or numbers, steps, actions, components, or combinations thereof.

Unless defined otherwise, all terms used herein, including technical or scientific terms, have the same meaning as commonly understood by those of ordinary skilled in the art to which this disclosure belongs. Terms such as those defined in a commonly used dictionary should be interpreted as having a meaning consistent with the meaning in the context of the related art and should not be interpreted in an ideal or excessively formal meaning unless explicitly defined in the present application.

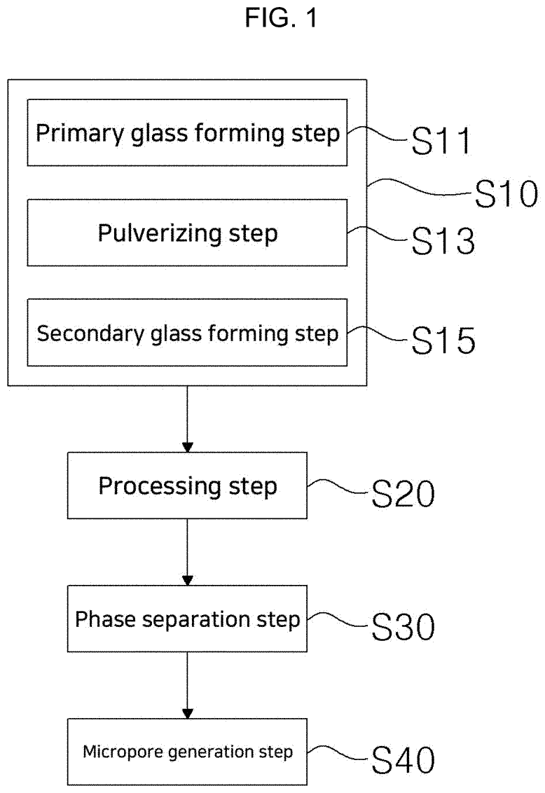

As shown in FIG. 1, the manufacturing method of a porous glass filter, according to the present disclosure, may be roughly divided into a glass forming step S10, a processing step S20, a phase separation step S30, and a micropore generation step S40.

In the glass forming step S10, raw material powders of alkali oxide (R₂O), boron trioxide (B₂O₃), and silica (SiO₂) are mixed, melted at a high temperature, and rapidly cooled to make alkali borosilicate glass.

Here, the alkali metal (R) of the alkali oxide (R₂O) includes Na, Li, K, and the like.

After mixing the raw material powder of alkali oxide (R₂O), boron trioxide (B₂O₃), and silica (SiO₂), put it in a platinum crucible, and heat the platinum crucible at 1300° C. in an electric furnace for 2 hours to melt the raw material powder, and the melting solution is poured into a graphite mold made of graphite having a hole of 12 mm in diameter and cooled to prepare a rod-shaped alkali borosilicate glass having a diameter of 12 mm.

The operation process of pouring a 1300° C. high temperature melting solution into a narrow hole with a diameter of 12 mm in a graphite mold is very dangerous. In order to reduce this risk, the glass forming step S10 may be composed of a primary glass forming step S11, a pulverizing step S13, and a secondary glass forming step S15.

In the primary glass forming step S11, raw material powders of alkali oxide (R₂O), boron trioxide (B₂O₃), and silica (SiO₂) are mixed, put in a platinum crucible, and melted by heating at 1300° C. in an electric furnace for 2 hours, and then is poured into a stainless plate and quenched to make alkali borosilicate glass.

In the pulverizing step S13, the alkali borosilicate glass made through the primary glass forming step S11 is pulverized into a glass powder having a size of 1 to 3 mm.

In the secondary glass forming step S15, the pulverized glass powder is filled in a graphite mold having a hole with a diameter of 12 mm, and the graphite mold is heated in an electric furnace at 1000° C. to melt the glass powder again to remove air bubbles and cool to make a rod-shaped alkali borosilicate glass.

When manufacturing glass from raw material powder, a high temperature of 1300° C. or higher is required, but once the glass is manufactured, the pulverized glass powder melts sufficiently even at 1000° C. and enters into a molten state without bubbles.

In the processing step S20, the alkali borosilicate glass manufactured in the glass forming step S10 is processed into a shape that is easy to mount on the gas sensor. In general, a processed shape is a thin disk shape and is processed into a circular or polygonal shape.

A glass disk having a thickness of 1 mm is prepared by slicing the rod-shaped alkali borosilicate glass manufactured in the glass forming step S10.

In the phase separation step S30, the glass disk is heat-treated at 550° C., which is the glass transition temperature of alkali oxide (R₂O), boron trioxide (B₂O₃), and silica (SiO₂), for 8 hours to form an alkali boro (R₂O—B₂O₃) phase and silica (SiO₂) phase separated.

In the micropore generation step S40, the phase-separated glass disk is heat-treated or acid-treated to elute the phase-separated boron trioxide (B₂O₃) from the glass disk, thereby forming micropores.

As a heat treatment method, the glass disk may be hydro-thermalized in a water bath at 95° C. for 3 hours and then dried at 110° C. for 1 hour.

When the glass disk is heat-treated or acid-treated in this way, most of the alkali boro (R₂O—B₂O₃) phase is eluted, leaving only about 2% to 3% remaining.

Micropores are formed by elution of such alkali boro (R₂O—B₂O₃) phase, and the micropore has a diameter in the range of 10 Å, and the pore volume of the micropores is 30% or more. The micropores are open on both sides, and combustible gases can pass through these micropores, but siloxanes or silicones larger than this size cannot pass through.

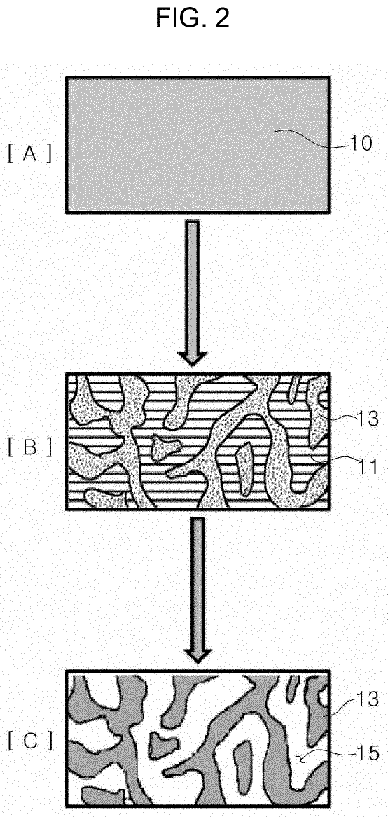

FIG. 2 is a view intuitively showing a manufacturing method of a porous glass filter according to the present disclosure.

[A] of FIG. 2 is a cross-section of the alkali borosilicate glass 10 manufactured through the glass forming step S10, and [B] is a cross-section of the alkali borosilicate glass phase separated into the alkali boro 11 phase, and the silica 13 phase through the phase separation step S30, A cross-section of the alkali borosilicate glass phase-separated onto the silica 13, and [C] is a cross-section of the porous glass filter in which pores 15 are made by eluting the phase-separated alkali 11 through the micropore generation step S40.

[Table 1] below relates to the composition and weight ratio of the porous glass filter according to the present disclosure using sodium (Na) as an alkali metal.

TABLE 1

| Sign | Na₂O (%) | B₂O₃ (%) | SiO₂ (%) | Al₂O₃ (%) |
|---|---|---|---|---|
| B₃₅Si₅₅ | 10 | 35 | 55 | 0 |
| B₄₀Si₅₀ | 10 | 40 | 50 | 0 |
| B₄₅Si₄₅ | 10 | 45 | 45 | 0 |
| B₅₀Si₄₀ | 10 | 50 | 40 | 0 |
| B₄₅Si₄₅Al₅ | 10 | 45 | 45 | 7.5 |
| B₅₀Si₅₀A₅ | 10 | 50 | 40 | 7.5 |

Six types of porous glass filters having a disk structure with a thickness of 1 mm were prepared for the composition having a weight ratio as shown in Table 1 above through a glass forming step S10, a processing step S20, a phase separation step S30, and a micropore generation step S40.

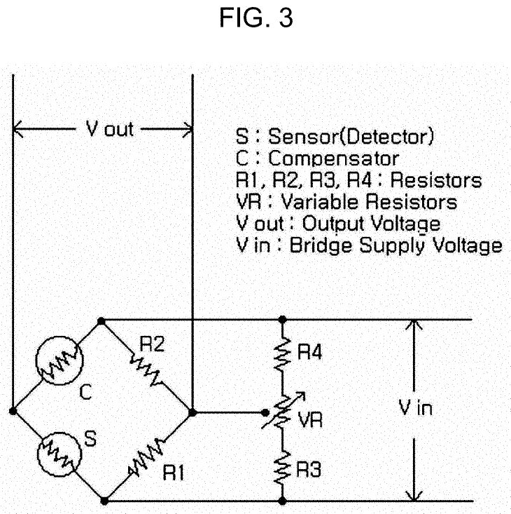

The manufactured porous glass filter is mounted on the gas sensor, and the gas sensor with the porous glass filter and the gas sensor without a filter is placed in a mixed gas environment of 2.5% CH₄, and 25 ppm HMDS, and the sensitivity change to methane CH₄ was measured using the measurement circuit shown in FIG. 3. In FIG. 3, ‘S’ is a sensing element, ‘C’ is a compensation element, ‘Vin’ is an input voltage, and ‘Vout’ is an output voltage, indicating sensor sensitivity.

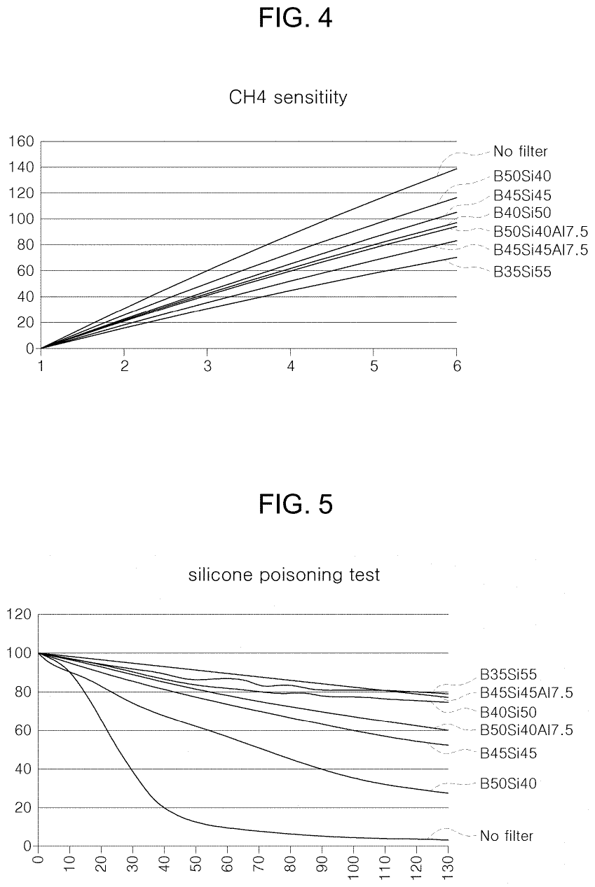

FIG. 4 shows the sensitivity change according to the methane concentration, and FIG. 5 shows the sensitivity change according to time.

As shown in FIG. 4, in the sensitivity change according to the methane concentration, the change rate is maintained constant in the gas sensor without a filter and the gas sensor equipped with each type of filter.

However, as shown in FIG. 5, in the sensitivity change over time, the change rate is constant in the gas sensor equipped with each type of filter, and the sensitivity gradually decreases over time, but in the gas sensor not equipped with the filter, the change rate in the gas sensor without the filter is rapidly increased, and after a predetermined time elapses, the sensitivity is decreased to a level to which gas detection is meaningless.

[Table 2] below relates to the composition and weight ratio of the porous glass filter according to the present disclosure using lithium (Li) as an alkali metal.

Since the Li₂O type has a wider phase separation region than the Na₂O type and has a lower glass transition temperature, the pore size becomes larger when porous glass is manufactured. Therefore, in order to reduce the pore size, 7.5% to 10% Al₂O₃ is added to suppress phase separation.

TABLE 2

| Sign | Li₂O (%) | B₂O₃ (%) | SiO₂ (%) | Al₂O₃ (%) |
|---|---|---|---|---|
| Si₅₅Al_{7.5} | 10 | 35 | 55 | 7.5 |
| Si₅₀Al_{7.5} | 10 | 40 | 50 | 7.5 |
| Si₄₅Al₁₀ | 10 | 45 | 45 | 10 |
| Si₄₀Al₁₀ | 10 | 50 | 40 | 10 |

After mixing the raw material powder of the composition according to [Table 2], the mixture is melted and quenched at 1300° C. to manufacture glass. After pulverizing, pulverized glass was added to graphite mold, melted at 1000° C., cooled at 1000° C., cut the glass rod to a thickness of 1 mm, heat treated at 480° C. for 10 hours, and dissolved Li₂O—B₂O₃ phase in 95° C. for 3 hours to prepare a porous glass filter.

The manufactured porous glass filter is mounted on the gas sensor, and the gas sensor with the porous glass filter and the gas sensor without a filter is placed in a mixed gas environment of 2.5% CH₄, and 25 ppm HMDS, and the sensitivity change to methane CH₄ was measured using the measurement circuit shown in FIG. 3.

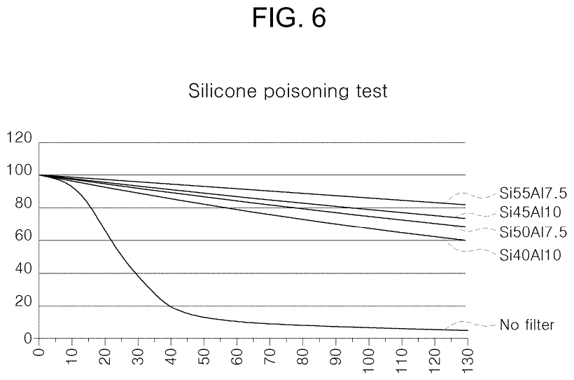

FIG. 6 shows the sensitivity change over time. In the gas sensor equipped with each type of filter, the change rate is rather constant and the sensitivity gradually decreases over time, but in the gas sensor without a filter, the change rate is rapidly increased, and after a predetermined time elapses, the sensitivity is decreased to a level to which gas detection is meaningless.

In the above description of the present disclosure, with reference to the accompanying drawings, a porous glass filter having a specific shape, structure, and procedure and a method for manufacturing the same have been described, but the present disclosure is capable of various modifications and changes by those skilled in the art. Changes should be construed as falling within the protection scope of the present disclosure.

What is claimed is:

1. A porous glass filter obtained by:
heat-treating alkali borosilicate glass having a composition comprising alkali oxide (R₂O), boron trioxide (B₂O₃), and silica (SiO₂) at a glass transition temperature to phase-separate the alkali borosilicate glass into an alkali boro (R₂O—B₂O₃) phase and a silica (SiO₂) phase; and
heat-treating or acid-treating the alkali borosilicate glass having undergone the phase separation to dissolve the alkali boro (R₂O—B₂O₃) phase.

2. The glass filter of claim 1, wherein the alkali borosilicate glass comprises 5% to 10% by weight of alkali oxide (R₂O), 35% to 50% by weight of boron trioxide (B₂O₃), and 40% to 55% by weight of silica (SiO₂).

3. A method of manufacturing a porous glass filter, the method comprising:
preparing alkali borosilicate glass by melting and cooling alkali oxide (R₂O), boron trioxide (B₂O₃), and silica (SiO₂);
heat-treating the alkali borosilicate glass at a glass transition temperature to phase-separate the alkali borosilicate glass into an alkali borosilicate (R₂O—B₂O₃) phase and a silica (SiO₂) phase;
heat-treating or acid-treating the phase-separated alkali borosilicate glass having undergone the phase separation to dissolve the alkali boro (R₂O—B₂O₃) phase, thereby generating micropores.

4. The method of claim 3, wherein the preparing of the alkali borosilicate glass comprises:
melting and cooling the alkali oxide (R₂O), boron trioxide (B₂O₃), and silica (SiO₂) to produce primary glass;
pulverizing the primary glass produced through the preparation of the alkali borosilicate glass; and
melting the pulverized primary glass in a graphite mold to remove air bubbles and then cooling the molten glass to produce the alkali borosilicate glass as secondary glass.
